(19) United States
(12) Patent Application Publication
(10) Pub. No.: US 2006/0003092 A1
(43) Pub. Date: Jan. 5, 2006

(54) Method of and slurry for texturing glass substrate of magnetic hard disk

(75) Inventors: Yuji Horie, Tokyo (JP); Hiromitsu Okuyama, Tokyo (JP); Tatsuya Tanifuji, Tokyo (JP)

Correspondence Address: BEYER WEAVER & THOMAS LLP, P.O. BOX 70250, OAKLAND, CA, 94612-0250, US

(73) Assignee: NIHON Microcoating Co., Ltd.

(21) Appl. No.: 11/223,393

(22) Filed: Sep. 8, 2005

Related U.S. Application Data
(63) Continuation of application No. PCT/JP04/05322, filed on Apr. 14, 2004.

(51) Int. Cl. B05D 5/12; B05D 3/12; B24D 3/02

(52) U.S. Cl. 427/127; 427/240; 51/307

(57) ABSTRACT

Texturing line marks are formed clearly and uniformly over a surface of a glass substrate for a magnetic hard disk such that there will be no abnormal protrusions exceeding 100 Å and the line density will be 30 lines/μm or more by rotating the glass substrate, supplying slurry on the surface of the glass substrate and pressing a processing tape on the surface of the glass substrate and running the processing tape. The slurry includes abrading particles of an artificial diamond material produced by a shock method and dispersed in a dispersing medium. The abrading particles include primary particles that are artificial diamond particles with average diameter 1 nm-20 nm and cluster particles with secondary particles that are artificial diamond particles with average diameter 0.05 μm-0.20 μm. The dispersing medium of the slurry includes water and an additive that contains higher aliphatic amide and two or more selected from the group consisting of glycol compounds, organic phosphates and surfactants.

This application is a continuation of International Application No. PCT/JP2004/005322, filed Apr. 14, 2004.

### BACKGROUND OF THE INVENTION

This invention relates to a method of texturing a glass substrate of a magnetic hard disk in order to produce texturing marks thereon, as well as to slurry used for such a method.

Increased data recording capacity and accuracy in reproduction are required of data processing devices such as computers for recording and reproducing character, image and voice data. Such data are recorded magnetically by means of a magnetic head on a magnetic hard disk and reproduced from such a magnetic hard disk.

Recording capacity of data and accuracy in reproduction depend largely on the distance (floating distance) between the surface of the magnetic hard disk and the magnetic head. In other words, the data recording capacity can be increased and accurate reproduction can be made possible by reducing and stabilizing the floating distance. For this reason, it is being required to stabilize the floating distance of the magnetic head at 50 nm or less.

In order to stabilize the floating distance of the magnetic head, to prevent the adsorption of the magnetic head onto the surface of the magnetic hard disk and further to improve the magnetic characteristics of the magnetic hard disk by providing magnetic directionality in the circumferential direction, approximately concentric circular line marks are formed on the surface of the magnetic hard disk.

In order to thus stabilize the floating distance of the magnetic head at 50 nm or less, to prevent the adsorption of the magnetic head and to improve the magnetic characteristics, it is required to form line marks with line density of 30 lines/μm (as the number of line marks crossing a line segment of length 1 μm in the radial direction of the magnetic hard disk) or more clearly and uniformly on the surface of the magnetic hard disk.

A magnetic hard disk is obtained by mirror-polishing a magnetic hard disk substrate and thereafter forming concentric circular line marks (referred to as texturing line marks) on this polished surface of the magnetic hard disk substrate and a magnetic layer and a protective layer thereon. The aforementioned line marks formed on the surface of the magnetic hard disk are approximately similar to the texturing line marks formed on the surface of the magnetic hard disk substrate.

Thus, if foreign objects are left on the surface of the magnetic hard disk substrate from the fabrication process and abnormally tall burrs or hills (hereinafter summarily referred to as abnormal protrusions) are formed, protrusions similar to these abnormal protrusions are formed on the surface of the magnetic hard disk and such protrusions collide with the magnetic head (referred to as head hits) to damage the magnetic head or the surface of the magnetic hard disk.

For this reason, an inspection is carried out to check whether or not abnormal protrusions exceeding 100 Å that may cause head hits are present on the surface of a magnetic hard disk substrate after a texturing process. If such abnormal protrusions are found, the magnetic hard disk substrate is discarded as a defective product.

As for the texturing line marks, unless they are clearly and uniformly formed over the surface of the magnetic hard disk substrate with a line density of 30 lines/μm or more, line marks with a line density of 30 lines/μm or more cannot be formed clearly and uniformly over the surface of the magnetic hard disk and it is not possible to stabilize the magnetic head at a small floating distance of 50 nm or less, to prevent its adsorption and to improve the magnetic characteristics. Thus, an inspection test is commonly carried out to check whether or not texturing line marks are formed clearly and uniformly over the surface of a magnetic hard disk substrate with a line density of 30 lines/μm or more.

The line density is generally examined from an enlarged image or a computer image of the magnetic hard disk surface after the texturing process obtained with the aid of a microscope such as an atomic force microscope. In order to examine whether or not texturing line marks are clearly and uniformly formed, use is usually made of a photograph obtained with a relatively low magnification ratio (generally about 4 times) by illuminating the surface of the magnetic hard disk surface with a light beam after the texturing process.

FIGS. 2-8 are examples of such photograph for the examination. FIGS. 2-4 are examples where clear texturing marks are formed uniformly in a concentric circular manner from a center area towards the outer periphery of a magnetic hard disk substrate. The photographs of FIGS. 5-8, by contrast, do not show clear texturing marks. Thus, glass substrates which have been processed as shown in FIGS. 5-8 are discarded as defective products. (The photograph in FIG. 4 shows clear texturing marks formed uniformly but the magnetic hard disk substrate has abnormal protrusions as will be explained below and is considered defective.)

In summary, a magnetic hard disk substrate is considered defective and discarded unless it passes not only the inspection test as described above but also another test on the presence or absence of abnormal protrusions.

As disclosed in Japanese Patent Publication Tokkai 3-147518, for example, a texturing process is carried out by supplying slurry with abrading particles dispersed therein to the surface of a rotating magnetic hard disk substrate and pressing and causing to run thereon a processing tape of a woven, non-woven or raised cloth made of a plastic fiber material.

An aluminum substrate with a surface subjected to an alumite processing or a non-magnetic plating process such as Ni—P plating has commonly been used as a magnetic hard disk substrate but a glass substrate with superior characteristics regarding flatness, smoothness and strength is coming to be popularly used. As disclosed in Japanese Patent Publications Tokkai 4-28013, 5-290369, 5-166176 and 8-241521, slurry with diamond abrading particles dispersed therein is used for the texturing of a glass substrate which is harder than an aluminum substrate. (See Japanese Patent Publication Tokkai 2000-141210 regarding slurry for texturing of an aluminum substrate.)

It is believed possible to form texturing line marks with a higher line density by using smaller abrading particles and to form texturing line marks more uniformly by using abrading particles with uniform radii.

As diamond abrading particles, natural diamond particles may be used as disclosed in Japanese Patent Publications Tokkai 4-28013, 5-290369, 5-166176 and 8-241521 or artificial diamond particles as disclosed in Japanese Patent Publication Tokkai 2000-136376.

When natural diamond particles are used as abrading particles, however, it is customary to mechanically break up a scrap of natural diamond and this usually makes it difficult to obtain uniformly sized particles with an average diameter of 0.1 μm or less and hence texturing line marks cannot be formed with a high line density of 30 lines/μm or more by using such abrading particles.

As disclosed in “Method of Producing Diamond and High-Pressure Technologies” by Masanori Akira, Gijutsu Kaihatsu News, No. 75 (January, 1998) (http://www.chuden.co.jp/torikumi/kenkyu/news/pdf/075/NO7503.pdf), for example, it has also been proposed to make use of particles of artificial diamond with diameter 20 nm or less produced by a static pressure method wherein carbon is mechanically compressed and dissolved in a molten metallic catalyst under a high-pressure, high-temperature condition and artificial diamond is deposited in its low-temperature part (Japanese Patent Publication Tokkai 2000-136376).

Since these are particles obtained by heating artificial diamond to convert the whole or a portion of its surface into non-diamond carbon, if they are used for the texturing of the surface of a glass substrate, the non-diamond carbon that covers the surface portion operates on the surface of the glass substrate and hence clear texturing line marks cannot be formed at a high line density of 30 lines/μm or more on the hard surface of the glass substrate.

Since it is difficult to form texturing line marks on the hard surface of a glass substrate by using slurry of the kind merely dispersing such diamond abrading particles, it has been known to add to the slurry a solution (such as potassium hydroxide solution having hydroxide groups) capable of chemically reacting with the surface of the glass substrate, as described in Japanese Patent Publications Tokkai 8-241521 and 2001-9694.

If a glass substrate is subjected to a texturing process by using such slurry having a chemically reacting solution added thereto, however, the texturing line marks become unclear although the surface roughness of the glass substrate can be made extremely small and the texturing line marks cannot be formed uniformly over the surface of the glass substrate. In other words, acceptable products cannot be produced thereby in a dependable manner.

Thus, in the technical field of production of magnetic hard disks, there still remains currently the problem of developing a texturing technology capable of producing in a dependable manner acceptable glass substrates of magnetic hard disk having no abnormal protrusions exceeding 100 Å and having texturing line marks clearly and uniformly formed with a line density of 30 lines/μm or more.

### SUMMARY OF THE INVENTION

It is therefore an object of this invention to provide a method of carrying out a texturing process such that the surface of a glass substrate will have no abnormal protrusions exceeding 100 Å and texturing line marks are clearly and uniformly formed with a line density of 30 lines/μm or more.

As a result of diligent investigations in view of the object described above, the present inventors have discovered that it is necessary in order to carry out a texturing process for forming texturing line marks clearly and uniformly on the surface of a glass substrate for a magnetic hard disk with a line density of 30 lines/μm or more to use abrading particles comprising primary particles with average diameter of 1 nm-20 nm and secondary particles with average diameter of 0.05 μm-0.20 μm such that the average surface roughness will exceed 4 Å.

Accordingly, a glass substrate of a magnetic hard disk embodying this invention has no abnormal protrusions exceeding 100 Å, has an average surface roughness exceeding 4 Å and has texturing line marks uniformly formed with a line density of 30 lines/μm or more. More preferably, the average surface roughness of a glass substrate of a magnetic hard disk according to this invention is in the range of 4 Å-7 Å.

The texturing process according to this invention is carried out by rotating a glass substrate, supplying slurry on the surface of the glass substrate, and pressing a processing tape on the surface of the glass substrate and running this processing tape.

The slurry comprises abrading particles and a dispersing medium for the abrading particles. The abrading particles comprise artificial diamond produced by a shock method and, in order to form texturing line marks with a line density of 30 lines/μm or more, include primary particles and cluster particles, the primary particles being of the artificial diamond thus produced and having average diameter 1 nm-20 nm and the cluster particles having average diameter 0.05 μm-0.20 μm and being secondary particles of (comprising a plurality of such primary particles). These abrading particles are contained in an amount of 0.02 weight % or more, and more preferable in the range of 0.02 weight %-3.0 weight %.

The dispersing medium comprises water and an additive. In order to carry out the texturing process such that the glass substrate will have no abnormal protrusions exceeding 100 Å and have an average surface roughness exceeding 4 Å and that texturing line marks can be formed clearly and uniformly, the additive comprises higher aliphatic amide and two or more selected from the group consisting of glycol compounds, organic phosphates and surfactants and is contained in an amount of 0.5 weight % or more of the slurry and more preferable in the range of 0.5 weight %-5 weight %.

The preferred content of higher aliphatic amide is 20 weight %-60 weight %, that of glycol compounds is 20 weight %-60 weight %, that of organic phosphate is 5 weight %-40 weight % and that of surfactant is 20 weight % or less, all with respect to the whole of the additive.

A tape having a surface portion made of a woven, non-woven, raised or flocked cloth material comprising fibers with thickness 0.1 μm-5.0 μm is preferably used as the processing tape.

By a method as described above, a surface with no abnormal protrusions exceeding 100 Å can be obtained on a glass substrate of a magnetic hard disk and texturing line marks can be formed clearly and uniformly on this surface with a line density of 30 lines/μm or more.

### BRIEF DESCRIPTION OF THE DRAWINGS

FIG. 1 shows a double-surface texturing apparatus used in a method of this invention.

FIGS. 2-8 are computer images of surfaces of glass substrates after a texturing process and their views when illuminated by light by means of an optical observation apparatus, corresponding respectively to Test Examples 1 and 9 and Comparison Examples 1, 2, 3, 4 and 5.

### DETAILED DESCRIPTION OF THE INVENTION

A glass substrate to be produced according to this invention is characterized as having no abnormal protrusions exceeding 100 Å, having an average surface roughness exceeding 4 Å and preferably 7 Å or less, and having texturing line marks clearly and uniformly formed with a line density of 30 lines/μm or more.

Examples of the kind of glass for the glass substrate include soda lime glass having silicon dioxide (SiO₂), sodium oxide (Na₂O) and calcium oxide (CaO) as main components, aluminosilicate glass having silicon dioxide (SiO₂), aluminum oxide (Al₂O₃) and R₂O (where R=potassium (K), sodium (Na) or lithium (Li)) as main components, borosilicate glass, lithium oxide (Li₂O)—SiO₂ type glass, Li₂O—Al₂O₃—SiO₂ type glass and R′O—Al₂O₃—SiO₂ type glass (where R′=magnesium (Mg), calcium (Ca), strontium (Sr) or barium (Ba)), as well as chemically reinforced type of glass obtained by adding zirconium oxide (ZrO₂) or titanium oxide (TiO₂) to these kinds of glass. Examples of glass to be used as glass substrate of this invention further include those obtained by chemically carrying out a surface reinforcing process (by immersing a glass substrate in a heated molten liquid of a mixed molten salt of potassium nitrate and sodium nitrate and replacing a portion of the ions on the surface of the glass substrate with ions having larger ion diameters). Crystallized glass with principal crystal comprising α-crysto-balite (α-SiO₂) and lithium dioxide (Li₂.SiO₂) may be used as glass substrate.

A glass substrate for a magnetic hard disk according to this invention is produced by carrying out a texturing process on a glass substrate.

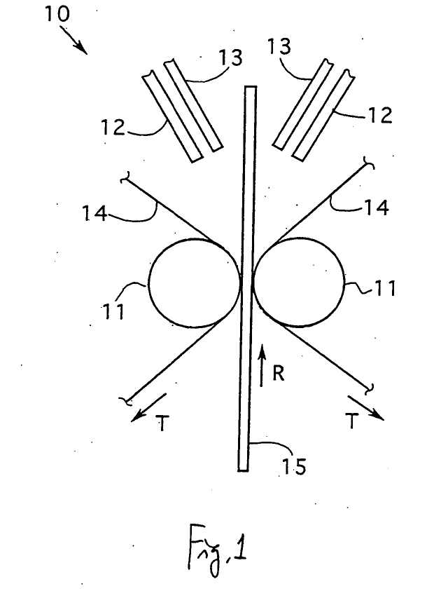

FIG. 1 shows an example of double-surface texturing apparatus, although a single-surface texturing apparatus (not shown) may be used instead for the purpose of this invention. As shown, the texturing process is carried out by setting a glass substrate 15 onto a shaft (not shown) connected to a driver motor and thereafter driving the driver motor to rotate the glass substrate 15 in the direction of arrow R. While slurry is supplied onto both surfaces of the glass substrate 15 through slurry nozzles 12, processing tapes 14 are pressed onto both surfaces of the glass substrate 15 through contact rollers 11 and caused to run in the directions of arrows T.

After the texturing process, a washing liquid such as water is blown onto both surfaces of the glass substrate 15 through washing nozzles 13 to carry out a washing process while the glass substrate 15 is caused to rotate continually in the direction of the arrow R.

The slurry comprises abrading particles and a dispersing medium for these abrading particles.

Abrading particles made of artificial diamond obtained by a shock method are used. Explained more in detail, particles of artificial diamond with average diameter of primary particles in the range of 1 nm-20 nm and cluster particles with average diameter in the range of 0.05 μm-0.2 μm and in the form of secondary particles (each comprising a plurality of primary particles) are used.

The cluster particles are agglomerates of 5-20 artificial diamond particles bound together in the form of a bundle. During a texturing process, small primary particles that form the cluster particles are pressed onto the surfaces of the glass substrate by means of the processing tapes, and lines of grooves that are to become the texturing line marks are thereby formed on the surfaces of the glass substrate with short intervals in between. In the meantime, the cluster particles that are pressed onto the surfaces of the glass substrate with an excessive force are broken up into smaller cluster particles or primary particles and since it is these smaller particles that operate on the surfaces of the glass substrate, clear texturing line marks can be formed uniformly over the surfaces of the glass substrate without forming unwanted scratches. In other words, since smaller primary particles operate on the surfaces of the glass substrate with an approximately even force, these texturing line marks can be formed clearly and uniformly.

The abrading particles are produced by the known shock method (also known as the explosion shock method) such as disclosed in Japanese Patent Publication Tokkai 2000-136376. According to this shock method, after a diamond material comprising graphite powder is compressed at a high temperature by providing a shock, impurities are removed so as to obtain artificially produced diamond particles. By this method, diamond particles with density in the range of 3.2 g/cm³-3.4 g/cm³ (as compared to the density of natural diamond which is 3.51 g/cm³) can be artificially obtained.

The rate at which abrading particles are to be contained is 0.02 weight % or over with respect to the whole of the slurry. If the content is less than 0.02 weight %, it is not possible of obtain clear and uniform texturing line marks. Since no significant change can be obtained in the number of texturing line marks or average surface roughness by increasing the content of the abrading particles beyond 3.0 weight %, it is preferable to set the upper limit of the content of the abrading particles at 3.0 weight % in order to limit the cost of the abrading particles to be employed.

The dispersing medium comprises water and an additive. The additive comprises higher aliphatic amide and at least two selected from the group consisting of glycol compounds, organic phosphates and surfactants.

The rate at which the dispersing medium is to be contained is 0.5 weight % or more with respect to the whole of the slurry. Since no significant change can be obtained on the surface of the glass substrate even if more than 5.0 weight % of dispersion medium is used, it is preferable to set the upper limit of the content of the dispersion medium at 5.0 weight % in order to limit the cost of the slurry.

Higher aliphatic amides function as a process accelerator capable of accelerating the speed of the processing. Examples of higher aliphatic amide that may be employed include oleic acid diethanol amide, stearic acid diethanol amide, lauric acid diethanol amide, ricinoric acid diethanol amide, ricinoric isopropanol amide, ersinic acid diethanol amide and tall oil aliphatic acid diethanol amide. Those with 12-22 carbon atoms are preferred. The rate at which higher aliphatic amides are to be contained is in the range of 20 weight %-60 weight % of the whole of the additive. If the rate of content is less than 20 weight %, the processing speed becomes too low. If it exceeds 60 weight %, abnormal protrusions (Rp) are generated.

Glycol compounds have affinity with abrading particles and hence function as a dispersant. Glycol compounds also serve to prepare a uniform dispersant because they have the effect of reducing the viscosity of the dispersant when the dispersant is prepared. Since they also have affinity with water, the glass substrate can be washed efficiently after the polishing process. Examples of glycol compound that can be used include alkylene glycol, polyethylene glycol, polypropylene glycol and diethylene butylether. The rate at which glycol compounds are to be contained is in the range of 20 weight %-60 weight % of the whole of the additive. If the rate of content is less than 20 weight %, the dispersion characteristic of the abrading particles is adversely affected. If it exceeds 60 weight %, it becomes difficult to form texturing line marks clearly.

Organic phosphates have the function of controlling the generation of abnormal protrusions (burs that are formed by polishing debris and become attached to the surface of the glass substrate) on the substrate surfaces. They are esters obtained by replacing a hydrogen atom of phosphoric acid (H₃PO₄) with alkyl or allyl group. Examples of organic phosphate that may be used include aliphatic salts and aromatic salts such as phosphates of polyoxyethylene nonylphenolether. The rate at which organic phosphates are to be contained is in the range of 5 weight %-40 weight % of the whole of the additive. If the content is less than 5 weight %, abnormal protrusions become likely to appear. If it exceeds 40 weight %, it becomes difficult to form texturing line marks clearly.

Surfactants have the effect of improving the dispersion capability of abrading particles. Examples of surfactant that may be used include nonionic and anionic surfactants. The rate at which surfactants are to be contained is 20 weight % or less of the whole of the additive.

Slurry may be produced by adding abrading particles to water, further adding thereto an additive comprising higher aliphatic amide and at least two selected from the group consisting of glycol compounds, organic phosphates and surfactants and stirring the mixture with a homo-mixer.

A tape of woven cloth, unwoven cloth, flocked cloth (having hair known as piles attached to the surface) or raised cloth with at least the surface portion (or the portion that contacts and actually acts on the surface of the glass substrate) comprised of fibers with thickness in the range of 0.1 μm-5.0 μm may be used as the processing tape. If the thickness of these fibers is less than 0.1 μm, the contact between the fibers on the surface portion of the polishing tape and the abrading particles in the polishing slurry diminishes and the abrading particles cannot act on the surface of the glass substrate sufficiently effectively. Thus, texturing line marks cannot be formed clearly. If the thickness of the fibers exceeds 5.0 μm, on the other hand, the step differences among the fibers forming the surface portion of the processing tape increase and texturing line marks cannot be formed uniformly on the surface of the glass substrate.

Comparison tests were carried out by using slurry samples (Test Examples 1-15 and Comparison Examples 1-7 to be described below) with dispersion media having different compositions for carrying out a texturing process on the surfaces of glass substrates (with diameter of 2.5 inches and thickness of 0.63 mm). Glass substrates that were preliminarily mirror-polished and had a surface reinforcing process carried out, having an average surface roughness (Ra) of 2-5 Å were used for these tests. The texturing process was carried out by using the double-surface surface processing apparatus shown in FIG. 1 and under the conditions shown in Table 1 below.

TABLE 1

| | | |
|---|---|---|
| Rotational speed of glass substrate | 300 | rpm |
| Travel speed of processing tape | 3.0 | inches/minute |
| Hardness of rollers | 45 | duro |
| Tension in tape | 11 | lbs |
| Oscillation frequency | 5.0 | Hz |
| Supply rate of slurry | 15 | ml/minute |
| Processing time | 20 | seconds |

In each of Test and Comparison Examples, artificial diamond particles (primary particles) with average diameter 20 nm or less produced by a shock method (explosion synthesis method) were used as abrading particles. The average diameter (D50) of the cluster particles (secondary particles) comprising these artificial diamond particles was 0.1 μm. Also in each of Test and Comparison Examples, a tape of woven cloth with thickness of 700 μm comprising nylon fibers of thickness 2.0 μm was used as the processing tape.

Measurements of the following four kinds were made on each of Test and Comparison Examples:

(1) Atomic force microscope (product name: Dimension 3100, produced by Digital Instruments Corporation) was used to measure the average surface roughness (Ra) of the glass substrate after the texturing process.

(2) Atomic force microscope (product name: Dimension 3100, produced by Digital Instruments Corporation) was used to measure the maximum height difference (Rmax) between a hill and a valley on the glass substrate after the texturing process.

(3) If abnormal protrusions (Rp) exceeding 100 Å are present on the surface of the glass substrate after the texturing process, the glass substrate is considered defective and indicated in Tables 4 and 5 below by symbol “X”. If there is no such abnormal protrusion, the glass substrate is considered good and indicated in Tables 4 and 5 below by symbol “O”.

(4) Computer image photographs of the surfaces of the glass substrates after the texturing process were inspected to judge whether texturing line marks are clearly and uniformly formed with a line density of 30 lines/μm or more. The inspection was carried out by using an optical observation apparatus (product name VMX-2100, produced by Vision Psyt\dot{e}c Co. Inc., using metallic halide 180 W lamp as light source). The judgments by the use of this optical observation apparatus was carried out by using photographs (with a low magnification of about 4 times) of the surfaces of the glass substrates illuminated by light. If texturing line marks are not formed clearly and uniformly with a line density of 30 lines/μm or more, the glass substrate is considered defective and indicated in Tables 4 and 5 below by symbol “X”. If such texturing line marks are formed clearly and uniformly, the glass substrate is considered good and indicated in Tables 4 and 5 below by symbol “O”.

In Test Examples 1-15, texturing processes were carried out on the glass substrates by using slurry samples with compositions shown in Table 2 given below. Test results are shown in Table 4 given below. In Comparison Examples 1-7, texturing processes were carried out on the glass substrates by using slurry samples with compositions shown in Table 3 given below. The test results are shown in Table 5 given below.

TABLE 2

| | Pure | Abrading | | | | | |
|---|---|---|---|---|---|---|---|
| | water | particles | Additive | Higher aliphatic | Glycol | Organic | |
| Test | Wt % with respect of the whole of | | | amide | compound | phosphate | Surfactant |
| Example | slurry | | | Wt % with respect to the whole of additive | | | |
| 1 | 98.00 | 1.00 | 1.00 | 60 | — | 30 | 10 |
| 2 | 98.00 | 1.00 | 1.00 | 45 | 25 | 20 | 10 |
| 3 | 98.00 | 1.00 | 1.00 | 20 | 60 | 10 | 10 |
| 4 | 98.00 | 1.00 | 1.00 | 40 | 50 | — | 10 |
| 5 | 98.00 | 1.00 | 1.00 | 20 | 50 | 20 | 10 |
| 6 | 98.00 | 1.00 | 1.00 | 20 | 30 | 40 | 10 |
| 7 | 98.00 | 1.00 | 1.00 | 20 | 60 | 10 | 10 |
| 8 | 98.00 | 1.00 | 1.00 | 50 | 30 | 10 | 10 |
| 9 | 98.00 | 1.00 | 1.00 | 20 | 50 | 10 | 20 |
| 10 | 98.00 | 1.00 | 1.00 | 50 | 20 | 10 | 20 |
| 11 | 98.50 | 1.00 | 0.50 | 20 | 60 | 10 | 10 |
| 12 | 96.00 | 1.00 | 3.00 | 20 | 60 | 10 | 10 |
| 13 | 94.00 | 1.00 | 5.00 | 20 | 60 | 10 | 10 |
| 14 | 98.00 | 1.00 | 1.00 | 20 | 60 | 20 | — |
| 15 | 98.00 | 1.00 | 1.00 | 50 | 30 | 20 | — |

TABLE 3

| | Pure | Abrading | | | | | |
|---|---|---|---|---|---|---|---|
| | water | particles | Additive | Higher | Glycol | Organic | |
| Comparison | Wt % with respect of the whole | | | aliphatic amide | compound | phosphate | Surfactant |
| Example | of slurry | | | Wt % with respect to the whole of additive | | | |
| 1 | 98.00 | 1.00 | 1.00 | 100 | — | — | — |
| 2 | 98.00 | 1.00 | 1.00 | — | 100 | — | — |
| 3 | 98.00 | 1.00 | 1.00 | — | — | 100 | — |
| 4 | 98.00 | 1.00 | 1.00 | — | 80 | 10 | 10 |
| 5 | 98.00 | 1.00 | 1.00 | 15 | 70 | — | 15 |
| 6 | 98.00 | 1.00 | 1.00 | — | 20 | 40 | 40 |
| 7 | 98.00 | 1.00 | 1.00 | 70 | 10 | 10 | 10 |

TABLE 4

| Test Example | Ra(Å) | Rmax(Å) | Rp(Å) | Micro max |
|---|---|---|---|---|
| 1 | 4.51 | 64 | O | O |
| 2 | 4.75 | 63 | O | O |
| 3 | 5.26 | 65 | O | O |
| 4 | 5.14 | 73 | O | O |
| 5 | 4.92 | 66 | O | O |
| 6 | 4.64 | 70 | O | O |
| 7 | 4.78 | 68 | O | O |
| 8 | 5.65 | 63 | O | O |
| 9 | 5.13 | 73 | O | O |
| 10 | 5.69 | 84 | O | O |
| 11 | 4.60 | 76 | O | O |
| 12 | 4.82 | 75 | O | O |
| 13 | 5.02 | 65 | O | O |
| 14 | 4.81 | 77 | O | O |
| 15 | 5.55 | 80 | O | O |

TABLE 5

| Comparison | | | | |
|---|---|---|---|---|
| Example | Ra(Å) | Rmax(Å) | Rp(Å) | Micro max |
| 1 | 5.65 | 90 | X | O |
| 2 | 1.93 | 45 | O | X |
| 3 | 2.76 | 40 | O | X |
| 4 | 3.80 | 70 | O | X |
| 5 | 3.08 | 49 | O | X |
| 6 | 2.12 | 40 | O | X |
| 7 | 4.70 | 88 | X | O |

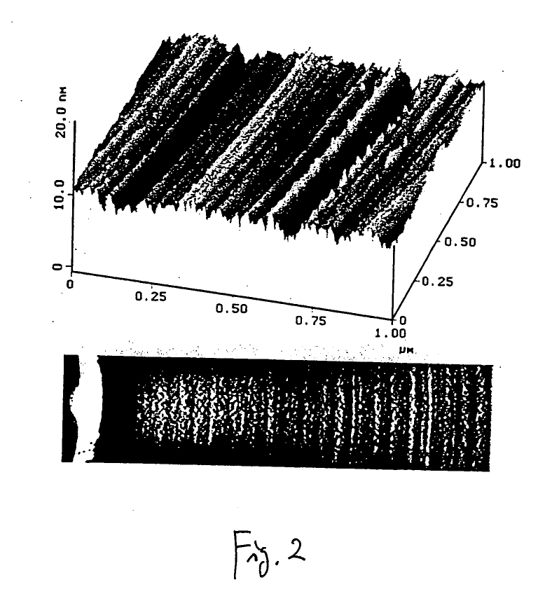

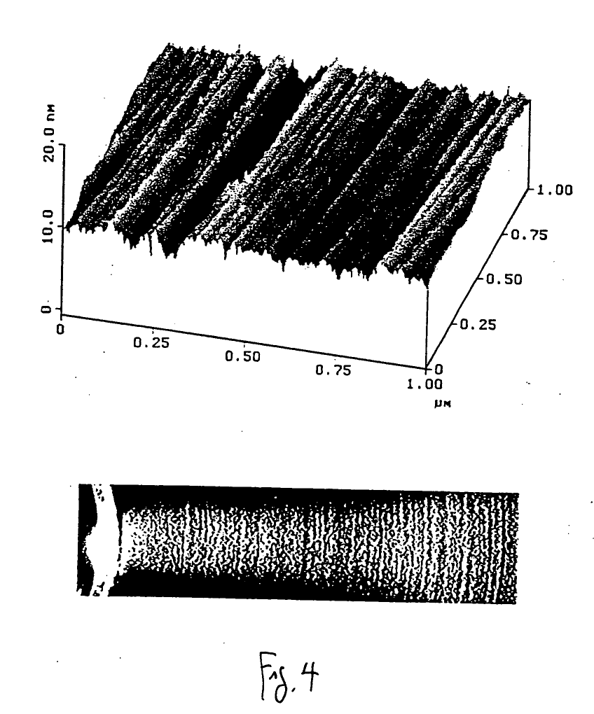

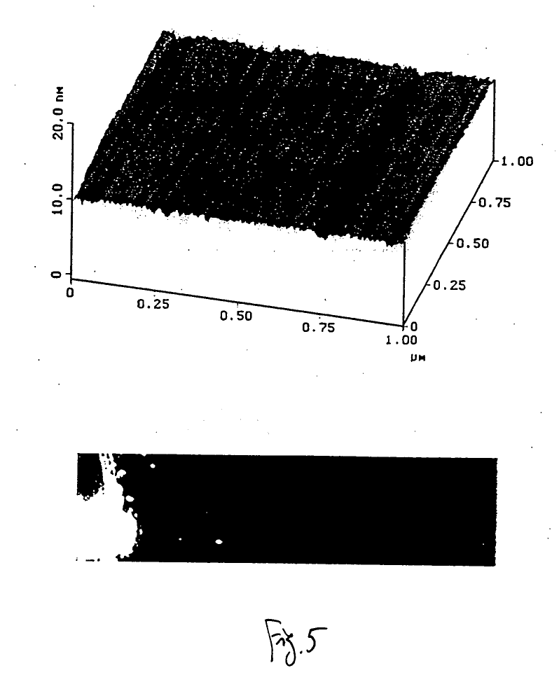

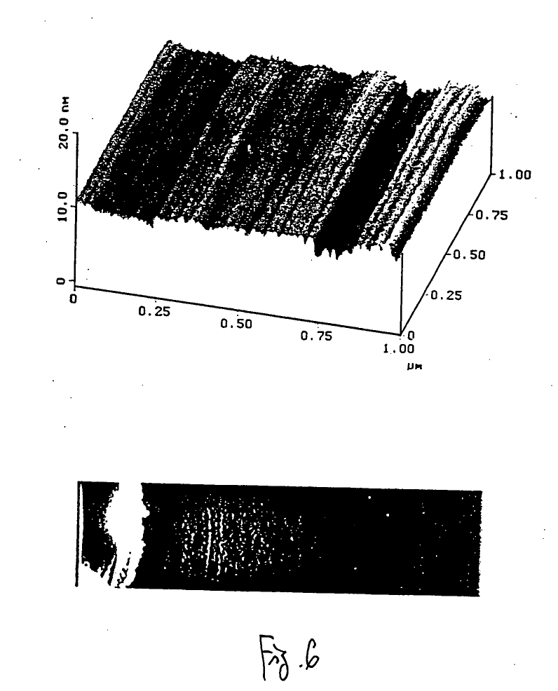

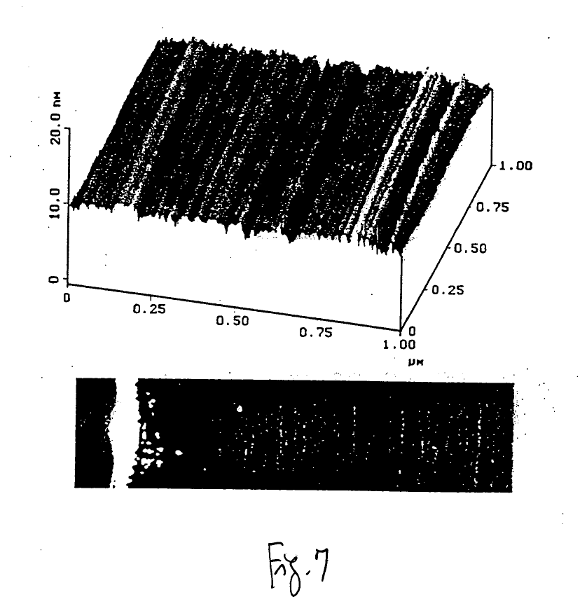

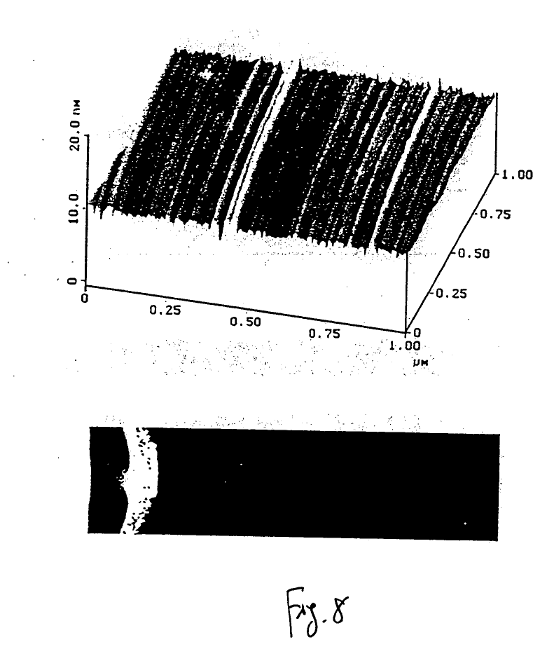

Although texturing line marks are not formed clearly and uniformly over the surface of the glass substrate if the average surface roughness (Ra) of the glass substrate is 4 Å or less (as shown by Comparison Examples 2-6 and in FIGS. 4-8), they can be formed clearly and uniformly if the average surface roughness exceeds 4 Å (as shown by Test Examples 1-15 and Comparison Examples 1 and 7 and in FIGS. 2, 3 and 4). This leads to the conclusion that a necessary condition for forming texturing line marks clearly and uniformly at a line density of 30 lines/μm or more is to carry out a texturing process on the surface of a glass substrate with average surface roughness exceeding 4 Å.

Although the average surface roughness of the glass surface may exceed 4 Å, abnormal protrusions exceeding 100 Å may be present (as shown by Comparison Examples 1 and 7). An investigation may lead to the conclusion that the average surface roughness exceeded 4 Å and texturing line marks were formed clearly and uniformly by Comparison Examples 1 and 7 because additives containing higher aliphatic amide were used but that abnormal protrusions were also formed because the content of higher aliphatic amide was too high (exceeding 60 weight % of the whole of the additive).

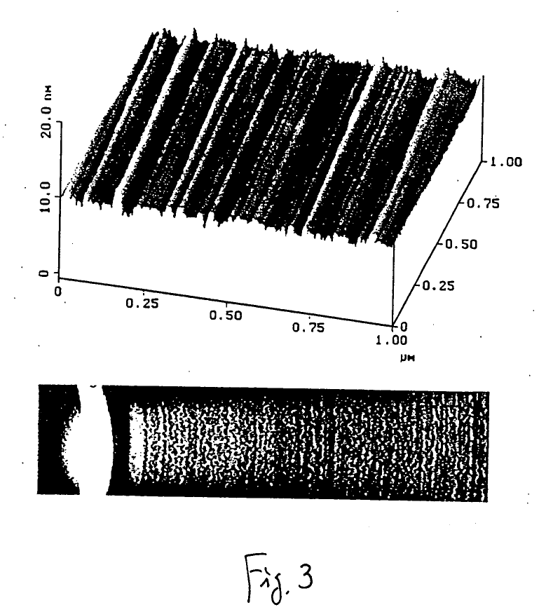

If slurry sample of a kind containing an additive by 0.5 weight % or more with respect to the whole of the slurry is used and if the additive comprises higher aliphatic amides within a range of 20 weight %-60 weight % (that is, not exceeding 60 weight %) and two or more selected from glycol compounds within a range of 20 weight %-60 weight %, organic phosphates within a range of 5 weight %-40 weight % and surfactants within a range of 20 weight % or less with respect to the whole of the additive, texturing line marks can be formed clearly and uniformly over a glass substrate with a line density of 30 lines/μm or more in the absence of abnormal protrusions exceeding 100 Å (as shown by Test Examples 1-15 and in FIGS. 2 and 3). In summary, texturing line marks can be formed clearly and uniformly with a line density of 30 lines/μm or more on the surface of a glass substrate in the absence of abnormal protrusions exceeding 100 Å if a method of this invention is employed.

What is claimed is:

1. A method of forming a surface of a glass substrate of a magnetic hard disk without abnormal protrusions exceeding 100 Å and having an average surface roughness exceeding 4 Å and forming texturing line marks uniformly on said surface with a line density of 30 lines/μm or more, said method comprising the steps of:
rotating said glass substrate;
supplying slurry on said surface of said glass substrate; and
pressing a processing tape on said surface of said glass substrate and running said processing tape;
wherein said slurry comprises abrading particles comprising artificial diamond produced by a shock method and a dispersing medium for said abrading particles, said abrading particles being contained in an amount of 0.02 weight % or more with respect to said slurry, said abrading particles including primary particles and cluster particles, said primary particles being of said artificial diamond and having average diameter 1 nm-20 nm, said cluster particles having average diameter 0.05 μm-0.20 μm and being secondary particles of said artificial diamond;
wherein said dispersing medium comprises water and an additive, said additive being contained in an amount of 0.5 weight % or more of said slurry;
wherein said additive comprises higher aliphatic amides in an amount of 20 weight %-60 weight % of said additive and two or more selected from the group consisting of glycol compounds, organic phosphates and surfactants; said glycol compounds being contained in an amount of 20 weight %-60 weight % of said additive, said organic phosphates being contained in an amount of 5 weight %-40 weight % of said additive, said surfactants being contained in an amount of 20 weight % or less; and
wherein said surface of said glass substrate is formed without abnormal protrusions exceeding 100 Å and with an average surface roughness exceeding 4 Å and texturing line marks are formed uniformly on said surface with a line density of 30 lines/μm or more.

2. The method of claim 1 wherein said abrading particles are contained in an amount of 0.02 weight %-3.0 weight % with respect to said slurry.

3. The method of claim 1 wherein said additive is contained in an amount of 0.5 weight %-5 weight % of said slurry.

4. The method of claim 1 wherein said processing tape having a surface portion made of a woven, non-woven, raised or flocked cloth material comprising fibers with thickness 0.1 μm-5.0 μm.

5. Slurry for using in a texturing of a glass substrate of a magnetic hard disk to obtain a surface without abnormal protrusions exceeding 100 Å and having an average surface roughness exceeding 4 Å and to form texturing line marks uniformly on said surface with a line density of 30 lines/μm or more, said slurry comprising:
abrading particles comprising artificial diamond produced by a shock method; and a dispersing medium for said abrading particles;
wherein said abrading particles are contained in an amount of 0.02 weight % or more with respect to said slurry;
wherein said abrading particles include primary particles and cluster particles, said primary particles being of said artificial diamond and having average diameter 1 nm-20 nm, said cluster particles having average diameter 0.05 μm-0.20 μm and being secondary particles of said artificial diamond;
wherein said dispersing medium comprises water and an additive, said additive being contained in an amount of 0.5 weight % or more of said slurry;
wherein said additive comprises higher aliphatic amides in an amount of 20 weight %-60 weight % of said additive and two or more selected from the group consisting of glycol compounds, organic phosphates and surfactants; said glycol compounds being contained in an amount of 20 weight %-60 weight % of said additive, said organic phosphates being contained in an amount of 5 weight %-40 weight % of said additive, said surfactants being contained in an amount 20 weight % of said additive or less.

6. The slurry of claim 5 wherein said abrading particles are contained in an amount of 0.02 weight %-3.0 weight % with respect to said slurry.

7. The slurry of claim 5 wherein said additive is contained in an amount of 0.5 weight %-5 weight % of said slurry.
